(19) United States
(12) Patent Application Publication
(10) Pub. No.: US 2009/0019473 A1
(43) Pub. Date: Jan. 15, 2009

(54) Method of delivering targeted advertising

(76) Inventor: Edward I. Lawson, Rockville, MD (US)

Correspondence Address: LITMAN LAW OFFICES, LTD., POST OFFICE BOX 15035, CRYSTAL CITY STATION, ARLINGTON, VA, 22215-0035, US

(21) Appl. No.: 11/822,733

(22) Filed: Jul. 9, 2007

(51) Int. Cl. H04N 7/10

(52) U.S. Cl. 725/35

(57) ABSTRACT

The method of delivering targeted advertising includes the steps of: performing market and business research on a selected business; determining a target audience for advertising for the selected business; creating an advertisement specific to the target audience; and, delivering the advertisement to the target audience through narrowcast television. Preferably, the advertisement, once developed, is also delivered to the target audience through alternative, traditional advertising methods, such as via print media or through narrowcasting via the Internet. In addition to the television narrowcasting, the advertisement is delivered through newspapers, magazines, fliers, and the like, with the particular form of the advertising being dependent upon the particular needs and desires of the user.

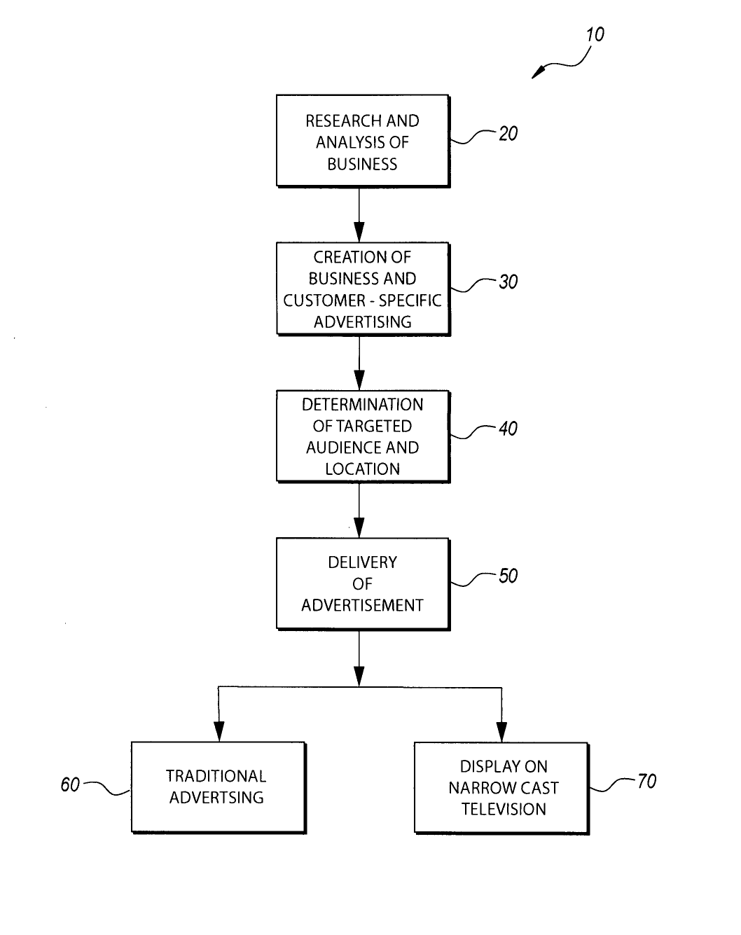

### BACKGROUND OF THE INVENTION

1. Field of the Invention

The present invention relates to a method of delivering advertising to a target audience. Particularly, the method includes delivery of advertising through a narrowcast delivery system coupled with traditional advertising methodology, such as, for example, advertising via print media.

2. Description of the Related Art

Traditional advertising and marketing typically consists of the creation of a single advertisement or a full advertising campaign, consisting of multiple advertisements, to be delivered to a general audience through a single medium. The advertisements may be displayed on billboards, shown on television, delivered via radio, printed in magazines or newspapers, or the like. Such advertising, however, is ineffective for two reasons: First, the advertisement is for a specific product or service, but is being delivered to a broad, general audience. Thus, a large percentage of funds for the advertising are being wasted on an audience who have no interest or need for the particular product or service. Second, typical advertising, as noted above, is generally delivered via a single medium, thus limiting exposure to the advertising campaign.

In order to avoid waste of advertising funds on a general audience, businesses often search for a particular target audience. A target audience is the primary group of people that the advertising campaign is aimed at appealing to. A target audience may consist of people of a certain age group, gender, marital status, etc. A certain combination, such as men from the ages of 20 to 30, is an example of a target audience. Other groups, although not the main focus, may also be interested in the particular product or service. Market research, which determines a target audience for a particular business is, thus, one of the most important stages in product and service sales. Without knowing the appropriate target audience, advertising and the selling of a particular product or service can become difficult and very costly to the business in question.

In a targeted marketing or advertising campaign, a marketing segment, which may include one or more target audiences, is determined. A targeting strategy is then generated, with the targeting strategy determining which segments to target, how many products to offer the targeted segment(s), and which products or services to offer to which segment. Targeting strategy decisions may be influenced by a variety of factors, such as, for example, market maturity, the diversity of potential buyers' needs and preferences, the strength of the competition, and the volume of sales required for profitibility.

Various tools and methods exist for marketing to targeted audiences. One such method is narrowcasting. A narrowcast is the transmission of data to a specific list of recipients. Cable television is an example of narrowcasting, since the cable television signals are sent only to homes that have subscribed to the cable service. In contrast, VHF and UHF television uses a broadcast model in which the signals are transmitted everywhere and anyone with a television antenna can receive them.

The Internet uses both a broadcast and a narrowcast model. Most web sites follow a broadcast model, since anyone with Internet access can view the sites. However, sites that require a user to log-in before viewing content are based on the narrowcast model. Push technologies, which send information to subscribers, are another form of narrowcasting. A particularly prominent example of narrowcasting is the usage of electronic mailing lists, where messages are sent only to individuals who subscribe to the list.

It should be noted that the terms “multicast” and “narrowcast” are often used interchangeably, although narrowcast typically refers to the business model whereas multicast refers to the actual technology used to transmit the data.

Narrowcasting is particularly useful as a commercial advertising tool. Pre-recorded television programs are often broadcast to captive audiences in taxi cabs, buses, elevators and queues (such as at branches of the Post Office in the United Kingdom), for example. The theory behind such narrowcasts is that, by identifying particular demographics viewing such programs, advertisers can better target their markets.

Various computerized and broadcast advertising systems and methods are known, however none are believed to show the particular combination of features and method steps taught by the present invention. Examples of such prior art systems and methods include U.S. Patent Application Publication 2006/0100930 A1; U.S. Patent Application Publication 2007/0061838 A1; and US Patent Application Publication 2006/0149632 A1, which are all herein incorporated by reference.

None of the above inventions and patent application publications, taken either singly or in combination, is seen to describe the instant invention as claimed. Thus, a method of delivering targeted advertising solving the aforementioned problems is desired.

### SUMMARY OF THE INVENTION

The method of delivering targeted advertising includes the steps of: performing market and business research on a selected business; determining a target audience for advertising for the selected business; creating an advertisement specific to the target audience; and, delivering the advertisement to the target audience through narrowcast television. Further, in the preferred embodiment, the advertisement, once developed, is also delivered to the target audience through alternative, traditional advertising methods, such as via print media or through narrowcasting via the Internet. In addition to the television narrowcasting, the advertisement is delivered through newspapers, magazines, fliers, and the like, with the particular form of the advertising being dependent upon the particular needs and desires of the user.

The research, and subsequent analysis, of the selected business includes a determination of a target audience for the business's advertising based upon the particular field of industry of the business, and further upon the geographic location of the business, and particular geographic regions the business wishes to sell their products and services in.

In the preferred embodiment, the advertisements are delivered through a narrowcast television network, via cable television, the Internet or the like, to large screen televisions or other suitable displays, dependent upon the needs and desires of the user, which are preferably located in retail environments. Further, the user may embed the advertising within other user-selectable content, such as news, weather reports, sports reporting, trivia and the like, dependent upon the particular needs and desires of the user.

Preferably, the large-screen narrowcast televisions are located in retail environments, such as shopping malls, high-volume stores and the like, and in other environments with “captive” audiences, such as bars, restaurants and the like. Research, however, has shown that narrowcast broadcasting in such environments on its own is not necessarily an effective marketing tool. Thus, in order to guarantee to the subject business that providing customized advertisements via narrowcast broadcasting will be profitable to the business, the above-mentioned traditional marketing and advertising techniques (such as advertising in newspapers, magazines and the like) are used in addition to the narrowcast broadcasts. In this manner, full market penetration may be achieved, and the subject business will receive optimal returns from the outlay of advertising funds, as well as meeting the guarantee of enhanced business through these marketing and advertising techniques.

These and other features of the present invention will become readily apparent upon further review of the following specification and drawings.

### BRIEF DESCRIPTION OF THE DRAWINGS

The sole drawing Figure is a flow diagram illustrating the method of delivering targeted advertising according to the present invention.

Similar reference characters denote corresponding features consistently throughout the attached drawing.

### DETAILED DESCRIPTION OF THE PREFERRED EMBODIMENTS

The present invention is directed towards a method of delivering targeted advertising. As shown in the Figure, the method 10 includes the steps of: performing market and business research and analysis on a selected business (step 20); determining a target audience for advertising for the selected business (step 40); creating an advertisement or an advertising campaign specific to the target audience (step 30); and, delivering the advertisement or advertising campaign to the target audience through narrowcast television (steps 60, 70). Further, in the preferred embodiment, the advertisement, once developed, is also delivered to the target audience through alternative, traditional advertising methods, such as via print media or through narrowcasting via the Internet (step 60). The traditional advertising methods, used in conjunction with television narrowcasting, may include delivery through newspapers, magazines, fliers, direct mailing and the like, with the particular form of the advertising being dependent upon the particular needs and desires of the user.

The research, and subsequent analysis, of the selected business (step 20) includes a determination of a target audience for the business's advertising based upon the particular field of industry of the business, and further upon the geographic location of the business, and particular geographic regions the business wishes to sell their products and services in. Such determination may include, for example, selected Zip Codes® for targeting audiences. Other factors may be used in the market research for determination of a target audience or audiences, dependent upon the particular needs and desires of the user.

The research preferably includes personalized interviews or the like, collecting data on the selected business, and analyzing the business from a marketing standpoint. A target audience is determined, based upon the nature of the business and the geographic considerations of the business, and a long-term marketing and advertising strategy is generated. Based upon the particular nature of the business, the desired products and services to be sold, and the nature and geography of the target audience, an advertisement, in the form of commercials, print ads or the like, is generated, based upon all of the above factors.

The advertisement, which may include multiple pieces of advertising, is presented to a representative of the business, who either approves of the advertising campaign, or provides creative commentary for editing and revising the advertisement.

In the preferred embodiment, the advertisements are delivered through a narrowcast television network, via cable television, the Internet or the like, to large screen televisions or other suitable displays, dependent upon the needs and desires of the user, which are preferably located in retail environments. Although the narrowcast television may be delivered in any desired locale, dependent upon the particular needs and desires of the user, the displays are preferably located in high-traffic and volume shopping areas, thus resulting in direct response by targeted consumers. Further, the user may embed the advertising within other user-selectable content, such as news, weather reports, sports reporting, trivia and the like, dependent upon the particular needs and desires of the user.

As noted above, preferably, the large-screen narrowcast televisions are located in retail environments, such as shopping malls, high-volume stores and the like, and in other environments with “captive” audiences, such as bars, restaurants and the like. Research, however, has shown that narrowcast broadcasting in such environments on its own is not necessarily an effective marketing tool. Thus, in order to guarantee to the subject business that providing customized advertisements via narrowcast broadcasting will be profitable to the business, the above-mentioned traditional marketing and advertising techniques (such as advertising in newspapers, magazines and the like) are used in addition to the narrowcast broadcasts. In this manner, full market penetration may be achieved, and the subject business will receive optimal returns from the outlay of advertising funds, as well as meeting the guarantee of enhanced business through these marketing and advertising techniques.

It is to be understood that the present invention is not limited to the embodiments described above, but encompasses any and all embodiments within the scope of the following claims.

I claim:

1. A method of delivering targeted advertising, comprising the steps of:
performing research on a selected business;
determining a target audience for advertising for the selected business;
creating an advertisement specific to the target audience; and,
delivering the advertisement to the target audience through narrowcast television.

2. The method of delivering targeted advertising as recited in claim 1, further comprising the step of delivering the advertisement to the target audience through print media.

3. The method of delivering targeted advertising as recited in claim 2, further comprising the step of delivering the advertisement to the target audience through Internet delivery.

4. The method of delivering targeted advertising as recited in claim 1, wherein said step of determining a target audience for advertising for the selected business includes determination based upon the particular field of industry of the selected business.

5. The method of delivering targeted advertising as recited in claim 4, wherein said step of determining a target audience for advertising for the selected business includes determination based upon desired geographic sales of products and services of the selected business.

6. The method of delivering targeted advertising as recited in claim 1, wherein said step of delivering the advertisement to the target audience through narrowcast television includes display of the advertisement in retail environments.

7. The method of delivering targeted advertising as recited in claim 1, further comprising the step of delivering user-selectable content along with the advertisement being delivered by narrowcast television.
